(19) United States
(12) Patent Application Publication
(10) Pub. No.: US 2006/0129515 A1
(43) Pub. Date: Jun. 15, 2006

(54) Data totaling device, method thereof and storage medium

(75) Inventors: Masahiko Nagata, Kawasaki (JP); Masataka Matsuura, Kawasaki (JP); Kouichi Imamura, Kawasaki (JP); Nobuyuki Takebe, Kawasaki (JP); Kunimasa Koike, Kawasaki (JP); Junichi Wako, Kawasaki (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 11/096,267

(22) Filed: Mar. 31, 2005

(30) Foreign Application Priority Data
Dec. 10, 2004 (JP) 2004-358947

(51) Int. Cl. G06F 17/30

(52) U.S. Cl. 707/1

(57) ABSTRACT

Field information indicating the field of necessary data is obtained from data stored in each of one or more files. Then, the necessary data is automatically extracted from one or more files, according to the obtained field information and is stored in another file. Thus, necessary data stored in each file generated/accumulated by a plurality of application programs can be easily obtained.

### BACKGROUND OF THE INVENTION

1. Field of the Invention

The present invention relates to a technology for extracting necessary data from one or more files, generating necessary data and totaling or unifying the data in another file.

2. Description of the Related Art

In organizations, such as an enterprise and the like, an application program (hereinafter omitted as “application”) is widely used in order to efficiently do business. A function required for an application varies depending on business contents. Thus, most of organizations use a lot of applications.

An application is developed anticipating such data(file) that can be inputted and can be outputted in its respective position. Therefore, data (file) outputted by a specific application cannot be usually handled by another application. Thus, as shown in FIG. 1, some organizations prepare a data warehouse (DWH) server constituting a DWH to enable data to be transferred between applications. In FIG. 1, each of four key business systems and a mart sever correspond to data processing devices in which an application is installed. For example, point-of-sales (POS) data, hand held terminal (HHT) data and the like correspond to data accumulated in a key business system.

The DWH server provides each mart server with data mart extracted from a data warehouse storing the data of each key business system. Thus, for example, data generated and accumulated in each key business system is provided to each mart server as shown in FIG. 3.

The data warehouse presumes a relational database (RDB) technology. In the RDB, data structure is expressed in a table form. Each table usually eliminates the redundancy of original data (non-normalized data) to be managed as much as possible and totals only strongly related data. Thus, by normalizing data, the data warehouse usually targets and processes only normalized data.

Data mart necessary for a mart server (application) is modified from time to time. Since the data warehouse targets normalized data, the normalization must be newly made in accordance with the modification. In this case, data cleansing (form unification, overlap elimination, etc.) must be applied to non-normalized data required by the modification beforehand.

Traditionally, the data cleansing has been performed using an extract/transform/load tool (ETL) or the like. Therefore, a data mart could not be easily modified and cost increased.

Data to be managed by the data warehouse is generated by an application. Therefore, the data mart can also be modified by the update of the application. However, the update usually needs a long time and cost. For this reason, it is important to be able to cope with the modification of the data mart without the update of the application or the like.

Some data warehouses are provided with a tool for targeting one file and operating data stored in the file. However, as shown in FIG. 2, in reality, not a few data marts include the data of a plurality of key business systems. This means that the case where the prepared tool can be used is very limited. Therefore, it is very important to be able to cope with a plurality of files.

To cope with a plurality of files means to support a plurality of applications. If necessary data can be obtained from a file (data) accumulated by a plurality of applications, generally there is no need for an expensive data warehouse.

As the prior art reference of the present invention, there are Japanese Patent Application Nos. H10-105576 and H6-309343.

### SUMMARY OF THE INVENTION

It is an object of the present invention to provide a technology for automatically obtaining necessary data from a file (data) accumulated by a plurality of applications.

A storage medium for the first aspect of the present invention presumes that a data totaling device for extracting necessary data from one or more files and storing it in another file can access it. The storage medium records a program. The program realizes an information acquisition function for obtaining field information indicating the field of necessary data and data union function for extracting necessary data from one or more files, based on the field information obtained by the information acquisition function and storing it in another file on the data totaling device.

A storage medium for the second aspect of the present invention presumes that a data totaling device for storing data obtained by operating data stored in each of a plurality of files in another file can access it. The storage medium records a program. The program realizes an information acquisition function for obtaining operation information indicating an operation to be applied to data and data to be operated, an operation function for extracting data to be operated from a plurality of files and operating it, based on the operational information obtained by the information acquisition function and a data output function for outputting the data obtained by operated by the operation function to another file on the data totaling device.

A data totaling method of the present invention is a method for extracting necessary data from one or more files and storing it in another file. The data totaling method comprises preparing a program for extracting necessary data from one or more files, based on the field information indicating the fields of the necessary data and storing it in another file, and extracting necessary data from one or more files and storing it in another file by providing the program with the field information and executing it.

The present invention automatically extracts each piece of necessary data from one or more files, based on field information indicating the field of necessary data from one or more files and stores it in another file. Therefore, necessary data can be easily obtained from each file generated/accumulated by a plurality of applications. The necessary data can be easily modified by the modification of the field information.

The present invention also automatically extracts each piece of data to be operated from a plurality of files, based on operational information indicating an operation to be applied to data and data to be operated, operates it and outputs the data obtained by the operation to another file. Therefore, necessary data can be easily obtained from each file generated/accumulated by a plurality of applications. The necessary data can be easily modified by the modification of the operation information.

### BRIEF DESCRIPTION OF THE DRAWINGS

FIG. 1 shows how to realize the transfer of data between application programs using a data warehouse.

FIG. 2 shows an example of how to transfer data between the application programs by the realization method shown in FIG. 1.

FIG. 3A shows the summary of the process of the data totaling device in the preferred embodiment.

FIG. 3B shows an example of data stored in the master file M shown in FIG. 3A.

FIG. 3C shows an example of the configuration of a statistic hydra H generated by the master file M and totaling conditions SC shown in FIG. 3A.

FIG. 4 shows the functional configuration of the data totaling device in the preferred embodiment.

FIG. 5 shows an example of the hardware configuration of a computer capable of realizing the data totaling device in the preferred embodiment.

FIG. 6 shows the data structure of the master file (No. 1).

FIG. 7 shows the data structure of the master file (No. 2).

FIG. 8 shows the data structure of a journal file.

FIG. 9 shows another data structure of the journal file.

FIG. 10 shows the data structure of a temporary file.

FIG. 11 shows the data structure of a temporary file (in the case of a large number of records).

FIG. 12 shows the data structure of a totaling result file.

FIG. 13 shows an example of a command to generate a temporary file.

FIG. 14 shows an example of data stored in a connecting condition file.

FIG. 15 shows an anther example of data stored in a connecting condition file.

FIG. 16 shows an example of a command to generate a totaling result file.

FIG. 17 shows an example of the description of a group expression and a totaling expression.

FIG. 18 is a flowchart showing the generation process of a temporary file.

FIG. 19 is a flowchart showing the generation process of a totaling result file.

### DESCRIPTION OF THE PREFERRED EMBODIMENTS

The preferred embodiments of the present invention are described in detail below with reference to the drawings.

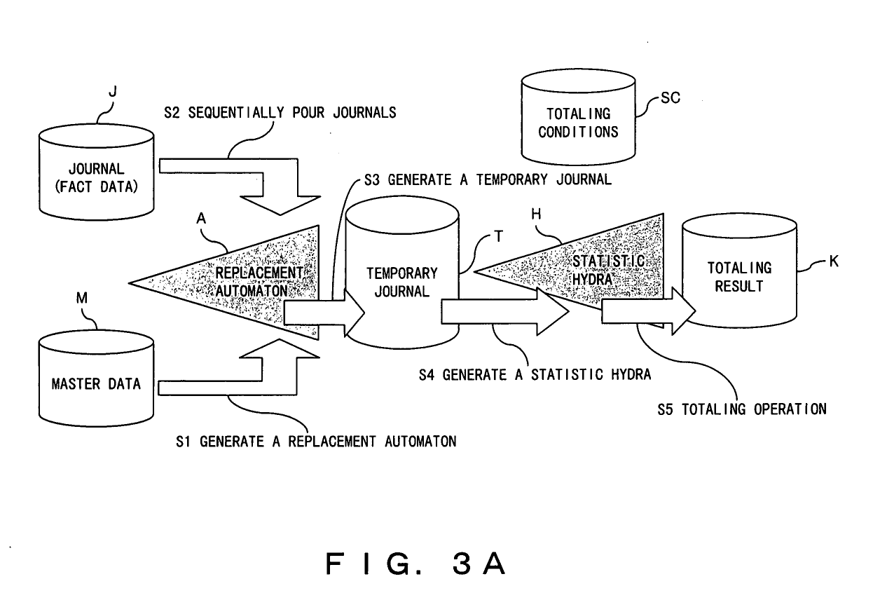

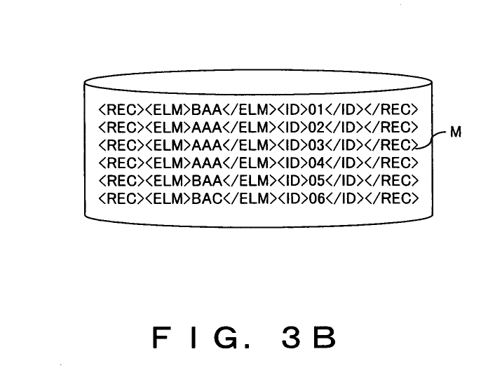

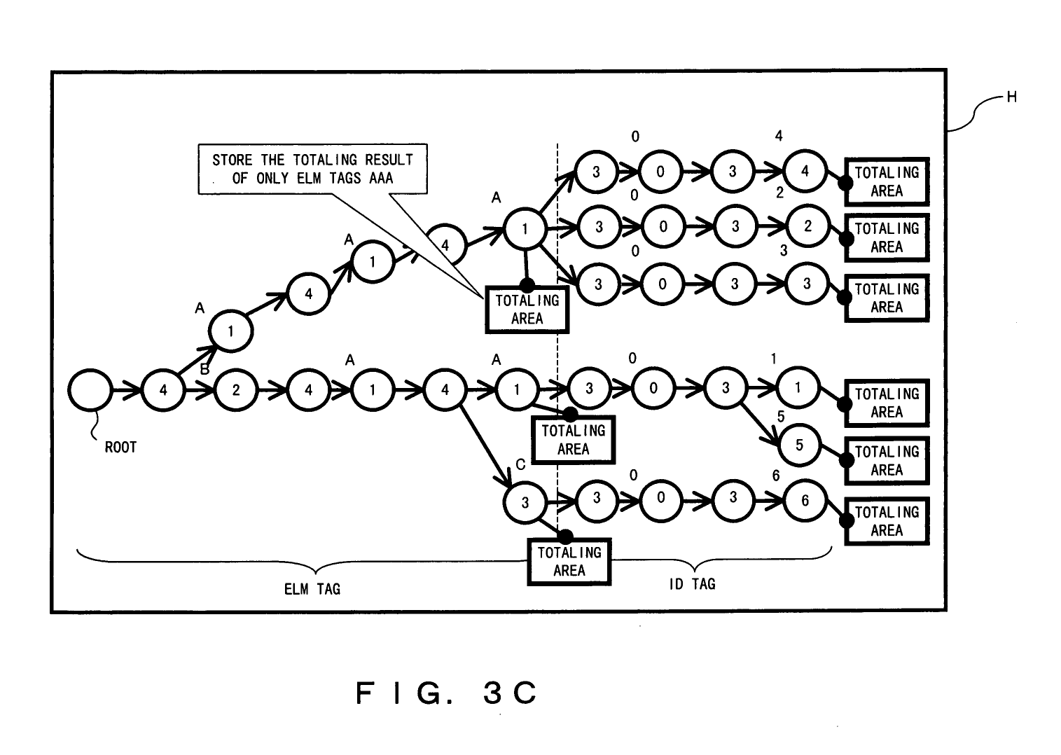

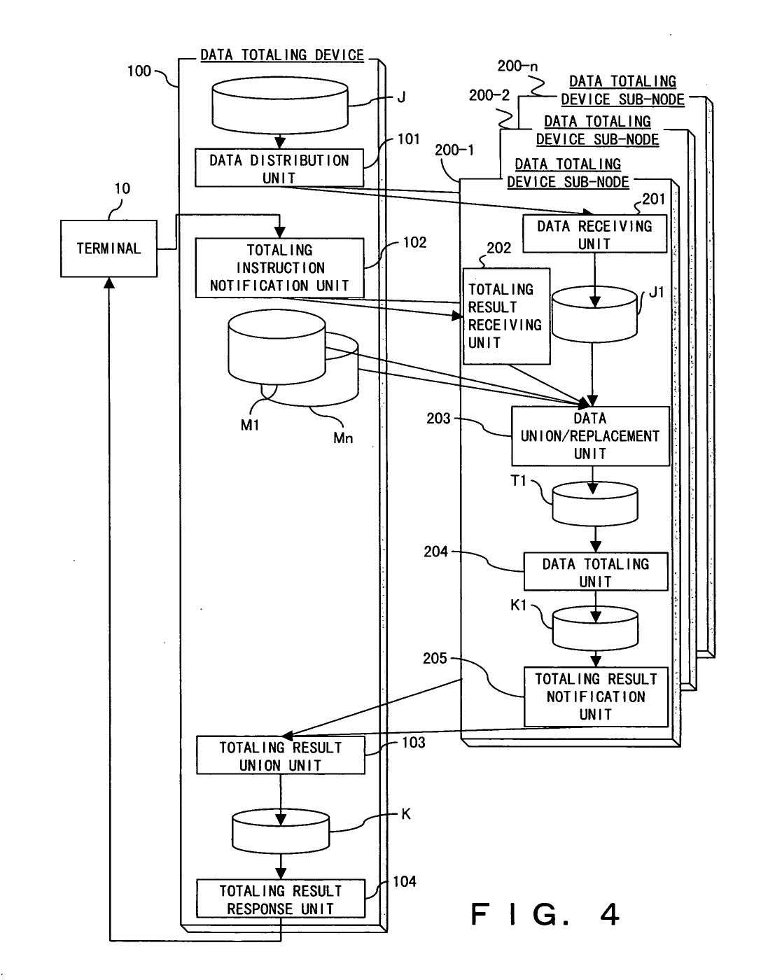

FIG. 3A shows the summary of the process of the data totaling device in the preferred embodiment. FIG. 4 shows the configuration of the data totaling device. In this preferred embodiment, as shown in FIG. 4, a data totaling device 100 is realized as a server for providing the user of a terminal device 10 connected to it via a network with a service.

Firstly, the summary of the process of the data totaling device (hereinafter called a “totaling device”) 100 is described with reference FIG. 3A. FIG. 3a shows the extraction of necessary data from a journal file J generated/accumulated by a specific key business system and a master file M storing the most basic business data. The journal file J stores fact data. Data stored in each of the files J and M is non-normalized data.

A replacement automaton A is a status transition table that is generated-using an algorithm adopted by a character string collation engine SIGMA published in 1981. The replacement automaton A is, for example, generated by slicing data that is the main key data stored in the master file M and by expressing the sliced data in a DFA structure after being converted based on preset operation information. The replacement automaton A generated thus has a feature that one time of data search is sufficient even if the number of data strings composed of a plurality of pieces of data increases, in other words, detection time is always constant. If a data generation unit repeatedly appears from one journal record by the main node specification function of the journal file J by the operational information, a temporary record is generated for each of the node appearance.

When extracting necessary data from the journal file J or the master file M, firstly, a replacement automaton A is generated using the master file M as described above (sequence S1). The replacement automaton A secures and generates an area for storing necessary data, that is, data that meets the conditions, for the termination node part of each branch and leaf. Then, the fact data stored in the journal file J is poured from top to end into the replacement automaton A in one direction one after another (sequence S2). In this case, the fact data to be stored in the replacement automaton A is substituted to a specified form. Each fact data is handled, for example, as one node. Then, a temporary file T is generated by substituting and uniting each of the files J and M (sequence S3).

After the temporary file T is generated, the temporary file T is read from top to end one after another, and a TRIE structure H is generated using the above-mentioned algorithm SIGMA (sequence S4). The TRIE structure H is a status transition table generated by the application technology of the replacement automaton A. In the termination node part of each branch and leaf specified by the totaling conditions SC, an area for storing other data is secured. In FIG. 3A, the generated TRIE structure (status transition table) H is notated as a “statistic hydra”. Hereinafter the description is used.

The totaling conditions SC indicates, for example, data to be statistically processed and its contents. The typical statistic process includes operations, such as the count of the number of data, the sum of numeric values, the extraction of a maximum value or a minimum value and the like. The area secured in the statistic hydra H is used to store data obtained by the statistic process.

FIG. 3B shows an example of data stored in the master file M. FIG. 3C shows an example of the configuration of a statistic hydra H generated by the master file M and totaling conditions SC.

The master file M shown in FIG. 3B stores each route element “REC” in which tags “ELM” and “ID” are disposed, as a record. In this case, each tag corresponds to a field.

The statistic hydra H shown in FIG. 3C is generated using the data (corresponding to “BAA”, etc.) of the tag “ELM” as a main key. The totaling area in FIG. 3C corresponds to the area secured for the statistic process. The totaling area shown in FIG. 3C is secured when each statistic process is specified to perform for each tag “ELM” and each combination of tags “ELM” and “ID” by the totaling conditions SC. Thus, a totaling area is secured for each tag “ELM” whose data is different and each combination of tags “ELM” and “ID” either data of which is different.

If the statistic process is further applied to all records, a totaling area is secured in the root. Since each totaling area always exists in any changing node, the statistic process result of a node nearby a root can total the statistic process results of farther off nodes.

After the statistic hydra H is generated, a totaling result file K is generated by performing statistic processes specified by the totaling conditions SC while sequentially shifting an attention-paying node from the root to the termination node and storing data obtained by the statistic process (sequence S5). The totaling result file K is provided to the terminal device 10 of the user.

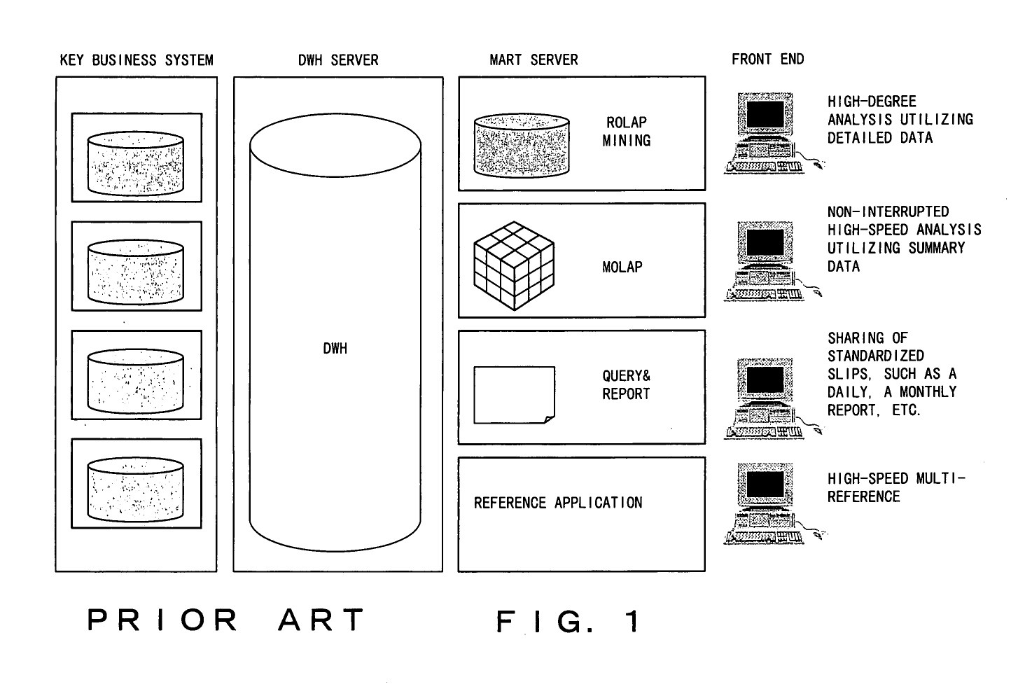

The totaling result file K generated as described above unifies normalized necessary data extracted from the journal file J and master file M and normalized data by the statistic process. In FIG. 1, the totaling result file K corresponds to mart data to be provided to a mart server. Therefore, even if a data warehouse is not prepared, the terminal device 10 of the user can utilize the data of each file generated/accumulated by a plurality of key business systems (applications). Data can be automatically extracted from those files and the statistic process can be automatically performed using the data. Therefore, data can be easily obtained from those files. Accordingly, mart data can be easily and rapidly modified.

Next, the functional configuration of the totaling device 100 for generating the totaling result file K as described above is described in detail with reference to FIG. 4.

In FIG. 4, to the totaling device 100, a plurality of data totaling device sub-nodes (hereinafter omitted as a “sub-node”), 200-1, 200-2, . . . , 200-n are connected. The process whose summary is shown in FIG. 3A is performed by the sub-node 200. In FIG. 4, the relationship between the sub-node 200 and its journal file J is indicated by attaching a symbol “J1” to a journal file possessed by a sub-node 2001. This also applies to a temporary file T and a totaling result file K.

The user of the terminal device 10 issues a totaling instruction to specify the file from which data should be extracted, the field of the data, statistic processes to be applied to the data and the like to the totaling device 100 to generate a totaling result file K. The totaling instruction is transmitted to the totaling device 100 via a network and then is transmitted to each sub-node 200 by a totaling instruction notification unit 102. Here for convenience sake, one sub-node 200 is assumed in the following description, otherwise specified.

A data distribution unit 101 transmits a journal J specified by the totaling instruction to the sub-node 200. The file J is received and stored by the data receiving unit 201 of the sub-node 200. The totaling instruction issued from the totaling instruction notification unit 102 is received by a totaling instruction receiving unit 202. Master files, M1, . . . , Mn managed or obtained by the totaling device 100 is transmitted to the sub-node 200, for example, according to the specification by the totaling instruction.

The data union/replacement unit 203 of the sub-node 200 extracts target data from the journal file J and master file M that are transmitted from the totaling device 100 to generate a temporary file T. Thus, sequences S1 through S3 shown in FIG. 3A are realized by the data union/replacement unit 203.

A part of the totaling instruction received by the totaling instruction receiving unit 202 is transmitted to the data totaling unit 204. The data totaling unit 204 generates a statistic hydra H (FIG. 3C) using the received totaling instruction and temporary file T, and generates a totaling result file K by performing a statistic process specified by the totaling instruction. Thus, sequences S4 and S5 shown in FIG. 3A are realized by the data totaling unit 204. The generated totaling result file K is transmitted to the totaling device 100 by a totaling result report unit 205.

To the totaling device 100, the totaling result file K is transmitting from the sub-node 200 that has transmitted the totaling instruction. The totaling result union unit 103 of the totaling device 100 collects and unites totaling result files K transmitted from each sub-node 200. The totaling result file K obtained thus or its information is transmitted to the terminal device 10 by a totaling result response unit 104.

Thus, the totaling device 100 extracts data required by the user from a plurality of files and provides the user of the terminal device connected to it via a network with it.

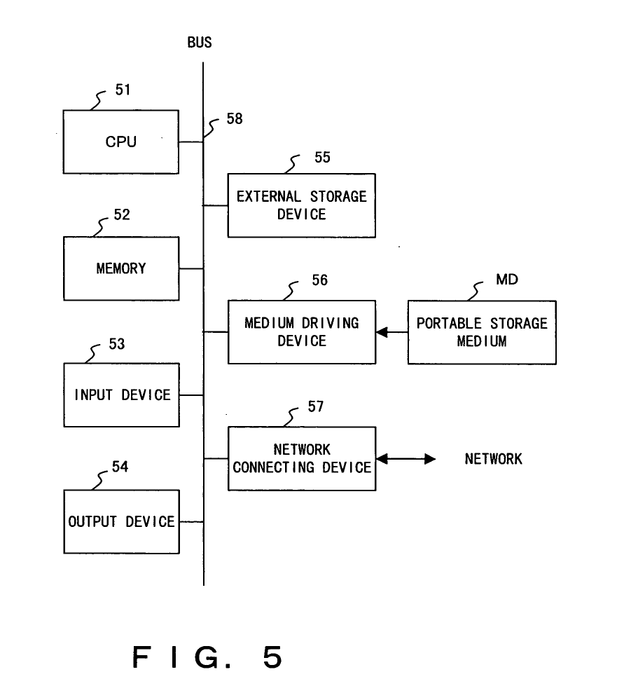

FIG. 5 shows an example of the hardware configuration of a computer capable of realizing the data totaling device. Although the totaling device 100 can also be realized by a plurality of computers (data processing devices), the description is made presuming that it is realized here by one computer whose configuration is shown in FIG. 5. Alternatively, it can be realized by one computer including the sub-node 200.

The computer shown in FIG. 5 comprises a central processing unit (CPU) 51, memory 52, an input device 53, an output device 54, an external storage device 55, a medium driving device 56 and a network connecting device 57, which are all connected to each other by a bus 58. The configuration shown in FIG. 5 is one example, and it is not limited to this.

The CPU 51 controls the entire computer.

For the memory 52, random-access memory (RAM) or the like is used, and it temporarily stores a program or data that are stored in the portable storage medium MD accessed by the external storage device 55 or medium driving device 56. The CPU 51 controls the entire computer by reading the program into the memory 52 and executing it.

The input device 53 is connected to input equipment, such as a keyboard, a mouse or the like, or possesses it. The input device 53 detects a user's operation for such input equipment and notifies the CPU 51 of the result of the detection.

The output device 54 is connected to output equipment, such as a display or the like, or possesses it. The output device 54 outputs data transmitted under the control of the CPU 51 on the display.

The network connecting device 57 is used to communicate with another device via a network, such as an intranet, the Internet or the like. For the external storage device 55, a hard disk device or the like is used. The external storage device 55 is used to mainly store a variety of data and a program.

The storage medium driving device 56 is used to access a portable storage medium MD, such as a flexible disk, an optical disk (including a compact-disk read-only memory (CD-ROM), a compact-disk recordable (CD-R), a digital versatile disk (DVD), etc.), a magneto-optical disk or the like.

The units 101 through 104 constituting the totaling device 100 shown in FIG. 4 can be realized by the CPU 51, memory 52, external storage device 55 and network connecting device 57 that are connected by the bus 58. The sub-node 200 can also be realized by a computer that possesses them.

Next, the process performed by the totaling device 100 and a method for performing the process are described in detail with reference to Fids. 6 through 17.

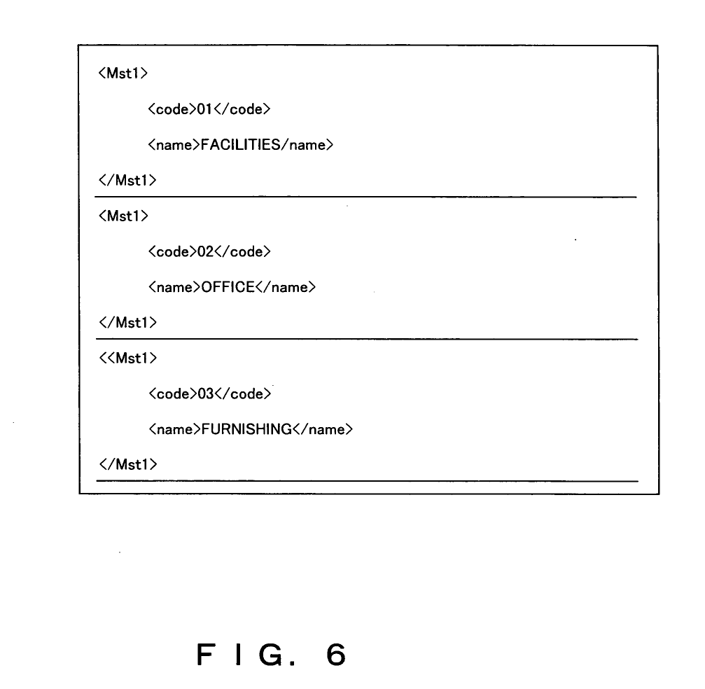

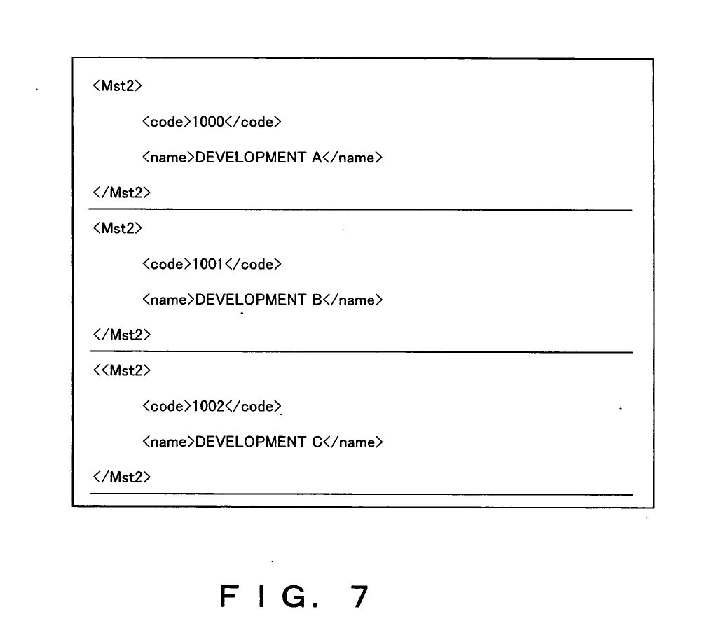

FIGS. 6 and 7 show the data structure of the master file M. The file M describes data in an extensible markup language (XML) format. Each element of tag names “Mst1” and “Mst2” corresponds to one record. Hereinafter, for convenience sake, the master files shown in FIGS. 6 and 7 are notated as master files M1 and M2, respectively.

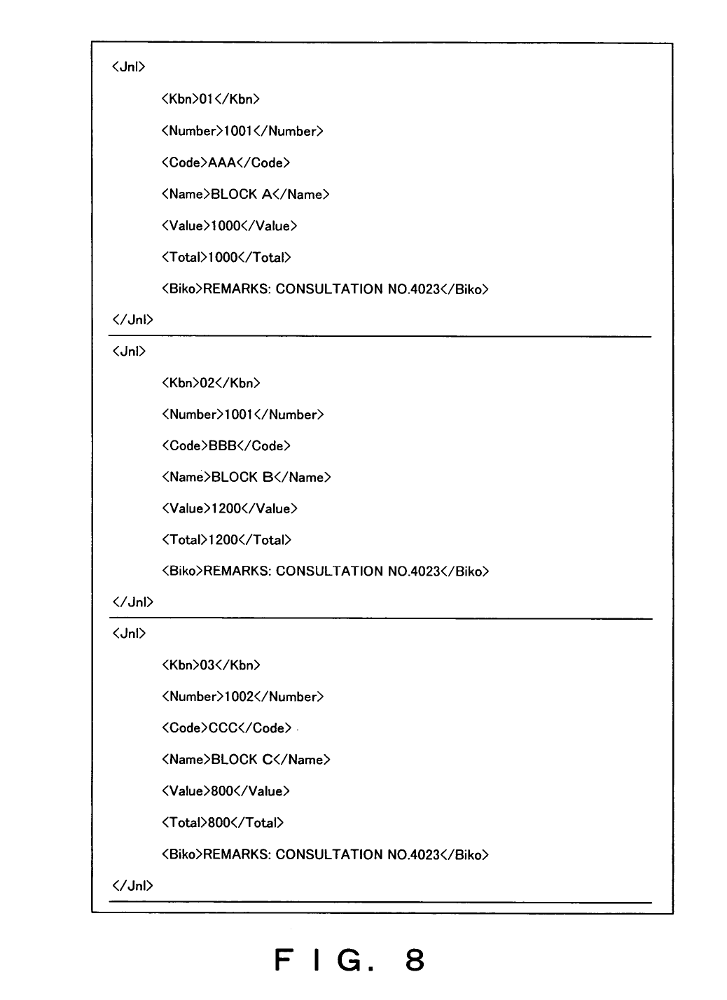

FIG. 8 shows the data structure of a journal file J. the file J also describes data in the XML format. Each element of a tag name “jn1” corresponds to one record.

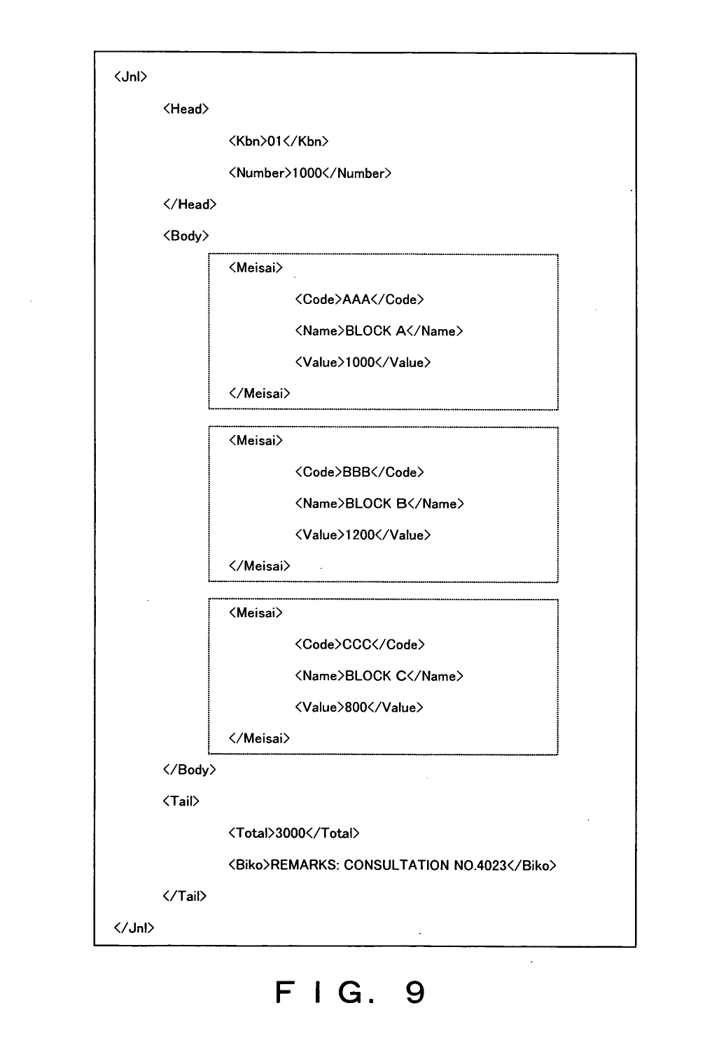

FIG. 9 shows another data structure of the journal file J. The data structure is obtained by describing the same contents as the journal file J shown in FIG. 8 by another method. A plurality of pieces of data different for each record is grouped as the elements of a tag name “Meisai”.

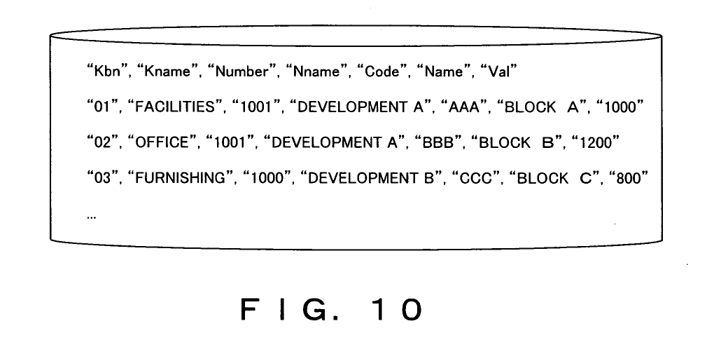

FIG. 10 shows the data structure of a temporary file T generated using the master files M1 and M2 shown in FIGS. 6 and 7, respectively, and the journal file j shown in FIG. 8 or 9.

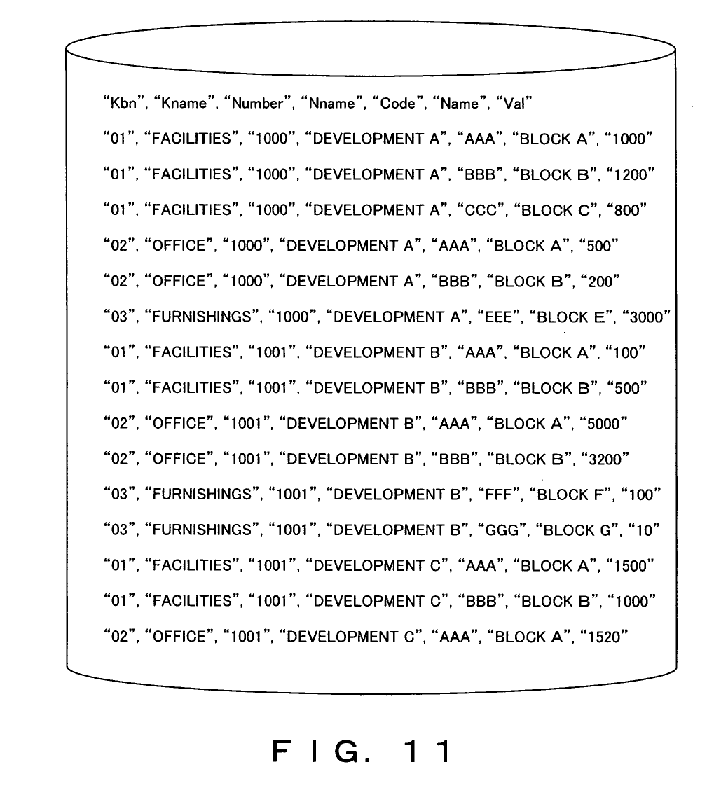

The temporary file T is different from the master file M and journal file J is a comma separated values (CSV) file. As shown in FIG. 10, in the file T, field labels 11 and data are outputted in the leading line and the second line and after with each quoted by double quotations and separated by a comma. FIG. 11 shows the data structure of a temporary file T in the case where the number of records in the journal file J is larger.

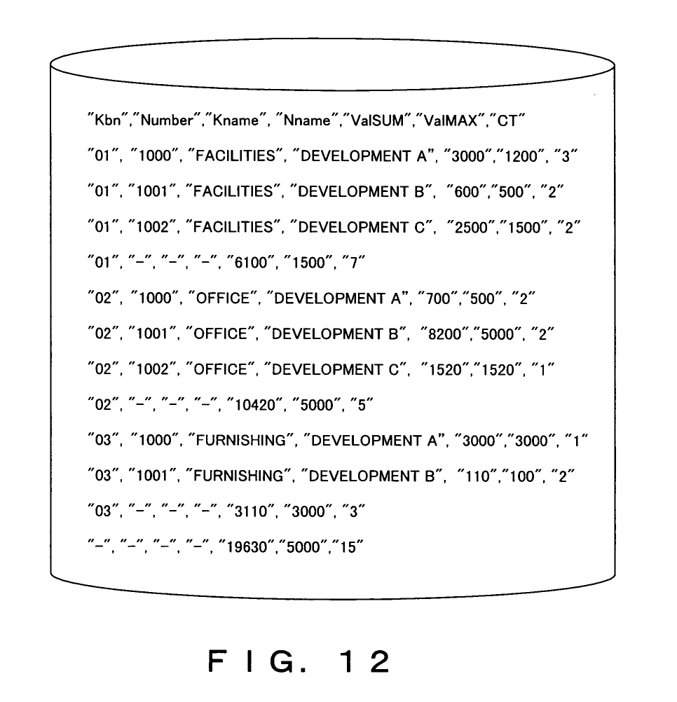

FIG. 12 shows the data structure of a totaling result file K generated using the temporary file T shown in FIG. 11.

Field labels in FIG. 12 that are not shown in FIG. 11, that is, “Va1SUM”, “Va1MAX” and “CT” are obtained by the statistic process. Lines with “−” are added in order to output the data by the statistic process.

The totaling result file K shown in FIG. 12 is generated using the temporary file T shown in FIG. 11. The temporary file T is generated using the master files M1 and M2 shown in FIGS. 6 and 7, respectively, and the journal files J shown in FIG. 8 or 9. In this example, using a case where the temporary file T is generated using the master files M1 and M2 shown in FIGS. 6 and 7, respectively, and the journal files J shown in FIG. 8 or 9, a method for generating them is described in detail.

In this preferred embodiment, the temporary file T and totaling result file K can be independently generated. Therefore, firstly, a method for generating the temporary file T is described in detail.

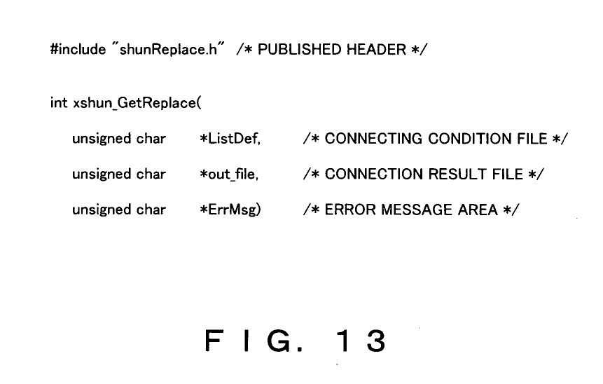

FIG. 13 shows an example of a command to generate a temporary file T. The command is described in the C language. In FIG. 13, “shunReplace.h” and “xshun_GetReplace” are the name of a file storing a program (function) for generating a temporary file T and its function name, respectively. The conditions for the generation of a temporary file T are defined by the arguments of the function “xshun_GetReplece”, “LlstDef” and “out_file” with “*” in FIG. 13.

The argument “ListDef” specifies information for accessing a target file and connecting conditions defining the field of data extracted from the file. The argument “out_file” specifies information indicating the output destination of the temporary file T. In this preferred embodiment, such information is specified by full-path. An argument ErrMsg is used to report an error message.

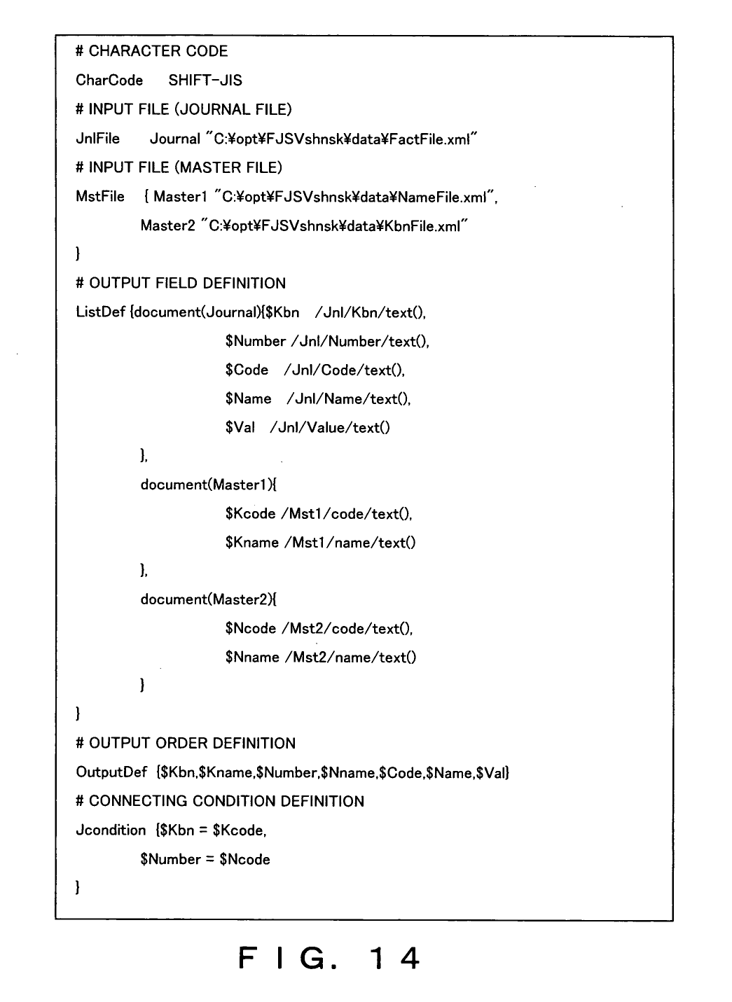

FIG. 14 shows an example of data stored in the connecting condition file. The data is used to generate a temporary file T using the journal file J shown in FIG. 8.

“CharCode”, “Jn1File”, “MstFile”, “ListDef”, “OutputDef” and “Jcondition” notated in FIG. 14 all are the names of parameters. The parameters “CharCode”, “Jn1File”, “MstFile”, “ListDef”, “OutputDef” and “Jcondition” specify a character identification code, a path to a journal file J, a path to a master file M, correspondence between a field label and an element, a field label of the data outputted to the temporary file T and the relationship between field labels of the same type, respectively.

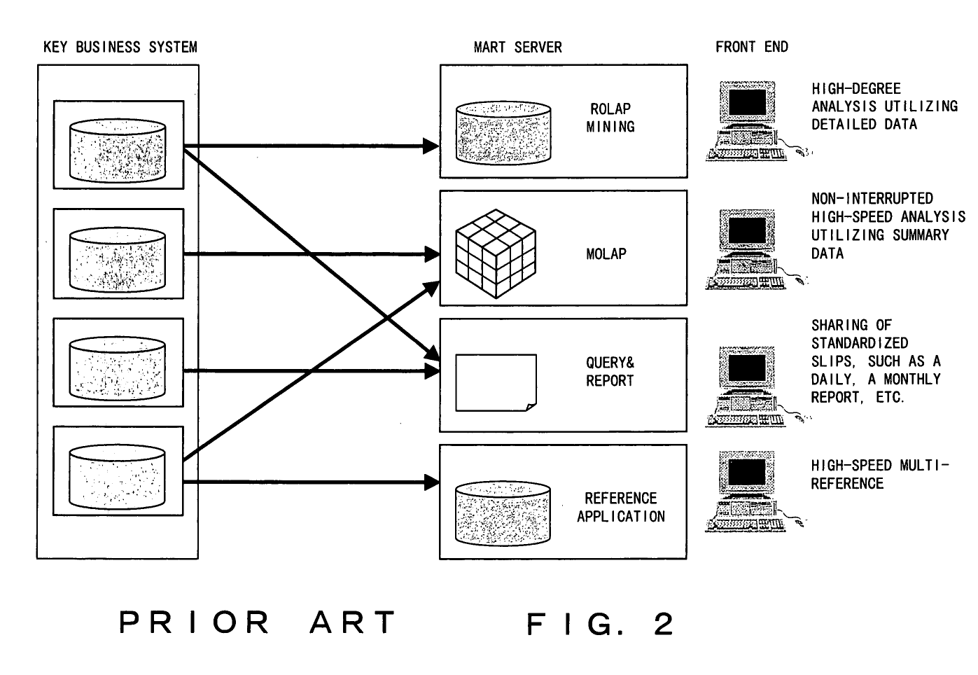

In FIG. 14, the parameter “Jn1File” defines that the journal file J shown in FIG. 8 is virtually handled as Journal. Similarly, the parameter “MstFile” defines that the master file M2 shown in FIG. 2 and the master file M1 shown in FIG. 6 are virtually handled as Master1 and Madter2, respectively.

The parameter “ListDef” defines the filed label of data stored as an element of the file for each virtual file. The field label is defined by a character string with “$” at top. Thus, for example, data with a field label “Kbn” is defined to be data stored as the element of a tag name “Number” disposed in the tag name “jn1”of the journal file J. “text( )” specifies the type of data. This applies to other cases. Data with a field label defined by the parameter “ListDef” is handled as an output target to the temporary file T.

Data specification by the parameter “Output Def” is performed by a field label described by the parameter “ListDef”. This also applies to the description of the relationship between field labels of the same type by the parameter “Jcondition”. Since a plurality of pieces of data of the same type must be defined by different field labels for each file, the description of the parameter “Jcondition” defines the relationship (connecting conditions) between records to be connected and handled among a plurality of files.

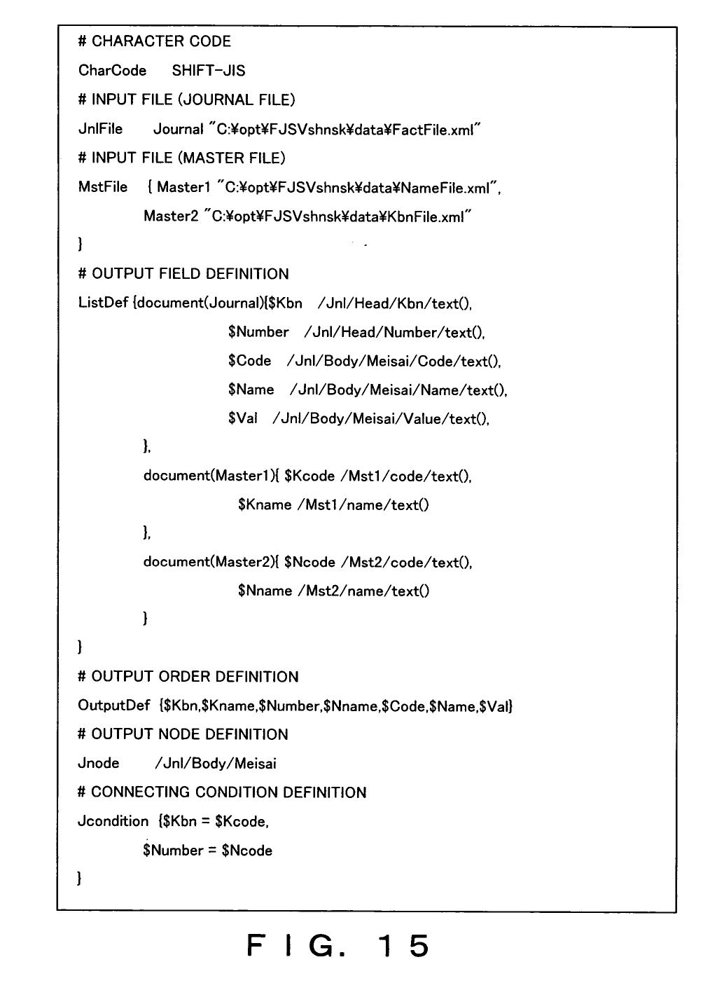

Of the above-mentioned parameters, the parameters “CharCode” and “MstFile” can be omitted. Another parameter “Jnode” can also be omitted. The parameter “Jnode” describes a record unit to be outputted to the temporary file T. Thus, if the journal file J shown in FIG. 9 is specified, as shown in FIG. 15, the description of the parameter “Jnode” is added to the connecting condition file. The description indicates that one record should be outputted for each element of a tag name “Meisai” disposed in a tag name “Body” of the route element “Jn1”.

The function “xshun_GetReplace” reads a connecting condition file specified by an argument, and for example, generates a replacement automaton A using a master file M specified by the file. The field of data to be extracted from the master file M is specified by the description (output field definition) of the parameter “ListDef”. The relationship between records to be connected between master files M is specified by the description of the parameter “Jcondition”. Similarly, the field of data to be extracted from a journal file J is specified by the respective descriptions of parameters “ListDef” and “Jcondition”. Data in the field specified thus is extracted from the journal file J and stored in the replacement automaton A.

The relationship between records to be connected among master files M sometimes cannot be specified. The case can be coped with, for example, by generating a replacement automaton A, paying attention to one of the master files M specified by the file and handling the remaining master files as journal files J.

The data stored in the replacement automaton A is written after writing the field label described as the parameter “OutputDef” into a temporary file T. Thus, the temporary file T shown in FIG. 10 or 11 is outputted. The output destination is specified as the argument “out_file”.

Thus, in the preferred embodiment, the user of the terminal device 10 can obtain the preferable temporary file T by specifying out put destination of connection condition file and temporary file T. Thereby, data extracted from journal file T or from master file M can be modified by connection condition file. Therefore, a connecting condition file can be easily updated, and data to be extracted from a journal file J or a master file M can be easily and rapidly updated.

Next, a method for generating a totaling result file K from the temporary file T shown in FIG. 11 is described in detail.

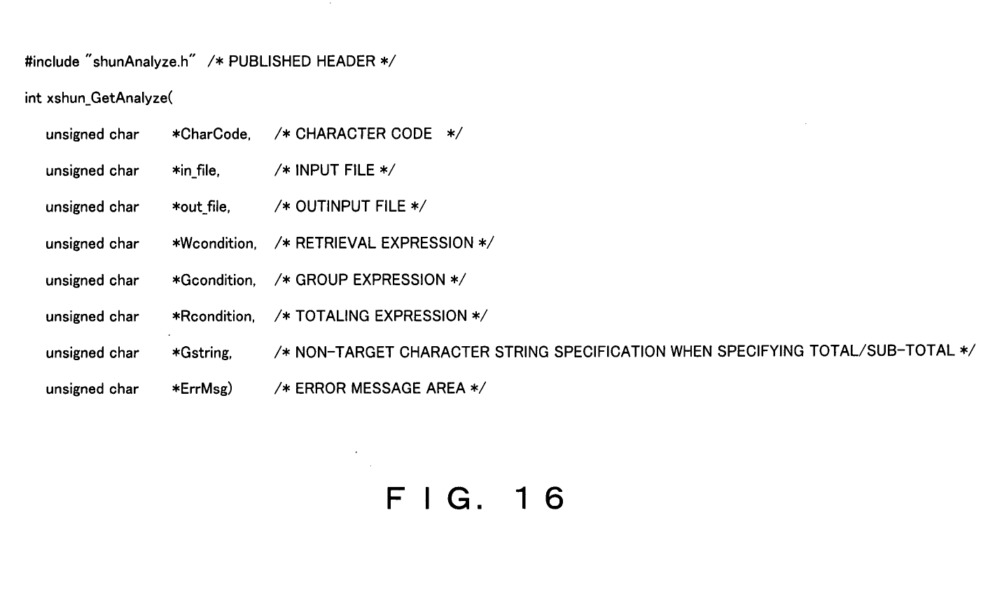

FIG. 16 shows an example of a command to generate a totaling result file K. the command is also described in the C language. In FIG. 16, “shunAnalyze.h” and “xshun_GetAnalyze” is the name of a file for storing a program (function) for generating a totaling result file K and its function name, respectively. Conditions for generating a totaling result file K are defined by the arguments of the function “xshunAnalyzw.h”, “CharCode”, “in_file”. “out_file”, “Wcondition”, “Gcondition”, “Rcondition” and “G string” with “*” in FIG. 16.

A file “shunAnalyze.h” and the above-mentioned “shunReplace.h” are stored, for example, in the totaling device 100 or the external storage device 55 (FIG. 5) installed in the sub-node 200. If it is stored in the totaling device 100, one of them can be transmitted to the sub-node 200, as required. Those files can also be accessed by recording them in a storage medium MD.

The parameter “CharCode” describes a character code (character identification code). The parameter “in_file” sets forth information indicating the access destination of a temporary file T. The parameter “out_file” sets forth information indicating the output destination of a totaling result file K. The parameter “Wcondition” sets forth a retrieval expression for selecting a record to which a statistic process should be applied from a temporary file T. This description can be omitted.

The parameter “Gcondition” describes a group expression which becomes the unit of a statistic process (totaling). The parameter “Rcondition” describes a format used to output data (totaling result) obtained by the statistic process. Data is normalized by the format. The parameter “Gstring” describes a character string to be outputted as the data with a field label not to be targeted when outputting a total or a sub-total as a totaling result. This description can be omitted. When omitted, “−” shown in FIG. 12 is outputted.

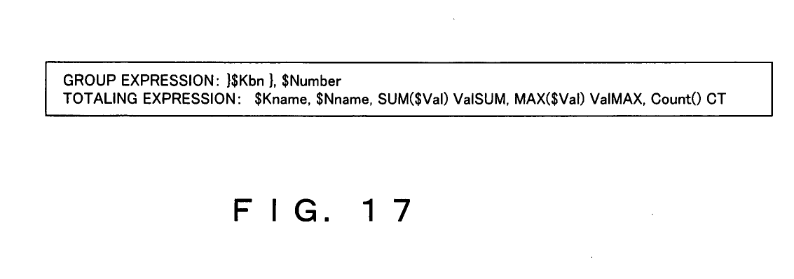

FIG. 17 shows an example of the description of the group expression and totaling expression.

“Kbn” and “Number” with “$” in the group expression are the field labels of data stored in the temporary file T. The field label set forth in the group expression indicates that records of the same data are totaled as one group. “}” in the group expression indicates the position of a group of records to be totaled. Specifically, “}” immediately after “$Kbn” indicates that records of the same data with the field label “Kbn” should be totaled as one group. “}” immediately before “$Kbn” indicates that records should be totaled as one group regardless of the field label “Kbn”, that is, all records should be totaled as one group.

In FIG. 12, a record in which “01”, “02” or “03” is outputted as data with the field label “Kbn”, and “−” is outputted as data with the field label “Number” or the like is added by “}” immediately after “$Kbn”. A record in which “−” is outputted as data with the field label “Kbn” is added by “}” immediately before “$Kbn”.

In the group expression, besides, “DESC”, “rlen”, “val” and the like can be set forth.

“DESC” is used to specify the rising/descending order of label output. “rlen” indicates a function and is described, for example, like “rlen($Kbn,n)”. The “n” after comma in the parenthesis is an integer for specifying the number of characters. The function extracts a specified integral number of characters from a character string stored as the data with the field label. “val” also indicates a function, and is described, for example, like “val($Kbn)”. The function extracts only numeric values from a character string stored as the data with the field label.

A symbol with “$” in the totaling expression is also a field label of data stored in the temporary file T. In “SUM($Val)ValSUM” with a parenthesis in the middle, indicates that a symbol before the parenthesis “SUM” is a function. The function totals data with the field label set forth in the parenthesis. “ValSUM” after the parenthesis is the field label of the total value. This meaning indicated by a symbol before/after a parenthesis also applies to other cases. A function “MAX” extracts the maximum value from the data with a field label set forth in a parenthesis. A function “Count” counts the number of target records. As functions, besides, “Ave” for calculating the average value of data, “MIN” for extracting the minimum value of data and the like are prepared.

The field of data to be stored in one record outputted to the totaling result file K is specified by the totaling expression. A record specified by the totaling expression is outputted for each group specified by the group expression.

The function “xshun_GetAnsalyze” totals records for each group specified by the group expression according to the described totaling expression, and outputs the totaling result to the totaling result file K after getting it together into one record. Thus, when the user of the terminal device 10 describes the group and totaling expressions as shown in FIG. 17 and instructs the generation of a totaling result file K from the temporary file T shown in FIG. 11, the contents of the file K becomes as shown in FIG. 12.

As described above, in this preferred embodiment, a field from which data is outputted, an operation to be applied to data in the field and a group of records to which the operation should be applied can be specified. Therefore, the user of the terminal device 10 can obtain data extracted from a temporary file T and a totaling result file K arbitrarily storing data obtained by an operation.

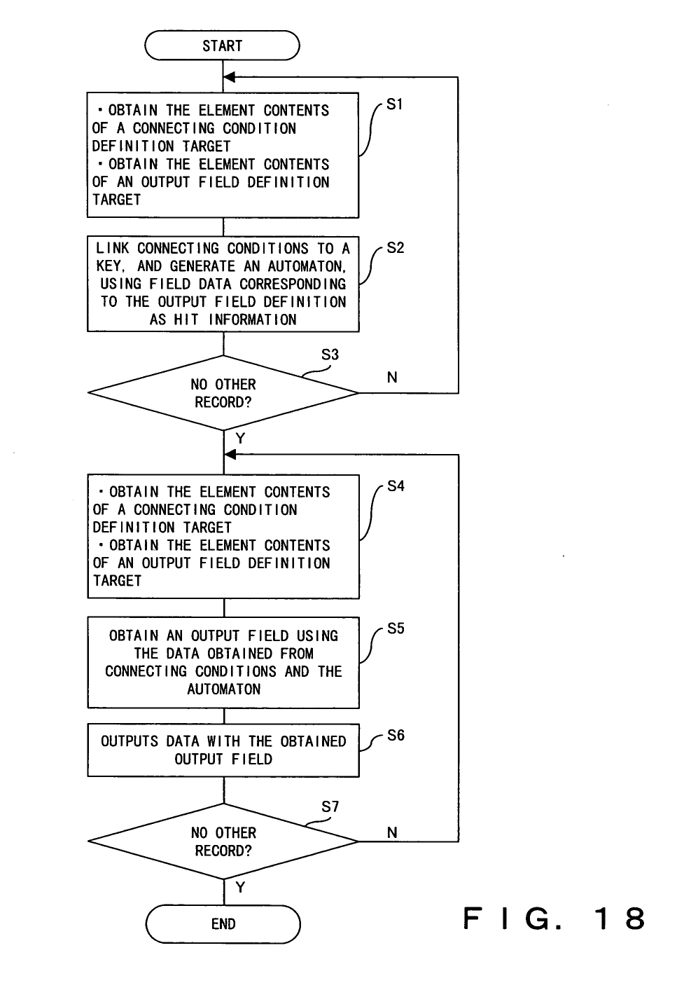

FIG. 18 is a flowchart showing the generation process of a temporary file. The generation process can be started in the sub-node 200 by the user of the terminal device 10 instructing the totaling device 100 to execute a command string as shown in FIG. 13. Next, the generation process is described in detail with reference to FIG. 18. To the sub-node 200, connecting conditions as shown in FIG. 14 or 15 and the like are also transmitted from the totaling device 100.

Firstly, in step S1, one record is read from each master file M specified in a connecting condition file, and data with a field to be extracted is extracted from those records, according to connecting condition definition set forth as a parameter “Jcondition” and output field definition set forth as a parameter “ListDef”. Then, in step S2, a replacement automaton A for one record is generated by connection the records, using the connecting condition definition as a key and extracting data with the field designated by the output field definition from each record. Then, in step S3, it is determined whether there is another record to be read from each master file M. If there is no record to be read, the determination is yes, and the process proceeds to step S4. Otherwise, the determination is no, and the process returns to step S1. Thus, another record is read.

If a plurality of master files M is specified and connecting conditions between them are defined, records to be connected are defined according to the contents of the record read from a specific master file M. Thus, step S1, for example, when a record is read paying attention to one master file M, from another master file M, a record to be connected to the record is read.

In step S4 and after, necessary data is extracted from a journal file J, using a generated replacement automaton A, and a process of outputting a temporary file T is performed.

Firstly, in step S4, one record is read from the journal file J, and data with an element specified by each of the connecting condition definition and output field definition is extracted from the record. In step S5, the replacement automaton A is referenced using the data extracted from the connecting condition definition; and data with the output field to be stored in the automaton A, out of the data extracted from the output field definition, is obtained. Then, the process proceeds to step S6.

In step S6, the data with the obtained output field is stored in the replacement automaton A. Then, in step S7, it is determined whether there is another target record to be read into the journal file J. If there is no such record, the determination is yes, and its field label name is stored in the first record, according to the descriptive contents (output order definition) of a parameter “OutputDef”. Then, temporary file T wherein the data stored in the replacement automaton A is stored for each termination node in the second and after records is outputted to the output destination (FIG. 13). Then, a series of processes terminate. Otherwise, the determination is no, and the process returns to step S4. Thus, another record is read from the journal file J.

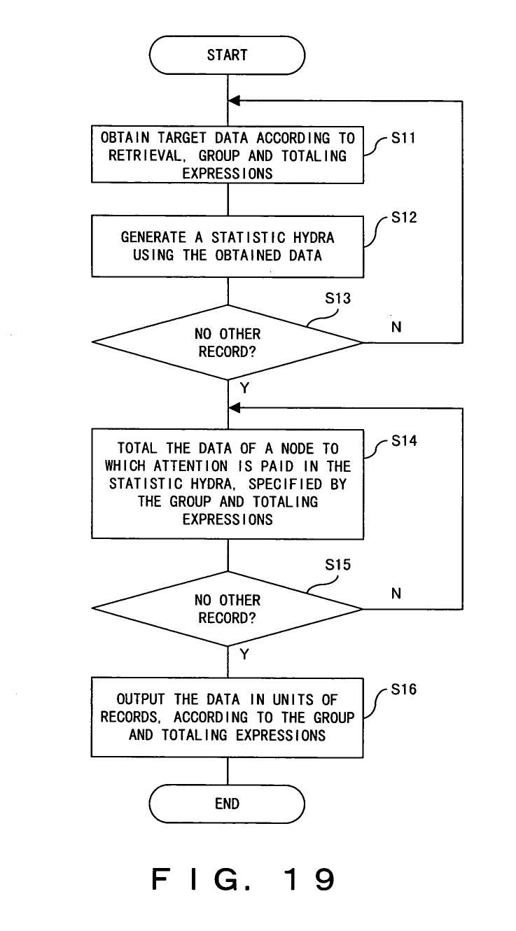

FIG. 19 is a flowchart showing the generation process of a totaling result file. The generation process is started in the sub-node 200 by the user of the terminal device 10 instructing the totaling device 100 to execute a command as shown in FIG. 16. Next, the generation process is described in detail with reference to FIG. 19.

Firstly. In step S11, one record is read from a specified temporary file T, and data with a target field is extracted from the record taking into consideration retrieval, group and totaling expressions. Then, in sep S12, a statistic hydra H (FIG. 3C) is generated using the data obtained by the extraction, according to the data. Then, in step S13, it is determined whether there is another target record to be read into the temporary file T. If there is no such record, the determination is yes, and the process proceeds to step S14. Otherwise, the determination is no, and the process returns to step S11.

The “yes” determination in step S13 means that data to be stored is all stored in the statistic hydra H from the temporary file T. Thus, in steps S14 and after, data is totaled using the statistic hydra H, and the process of outputting the totaling result as a totaling result file K is performed.

Firstly, in step S14, data specified by group and totaling expressions in a node to which attention is paid in the statistic hydra H is totaled. Then, in step S15, it is determined whether there is another node to which attention should be paid. If there is no such node, in other words, if totaling to be done is all performed, the determination is yes, and the process proceeds to step S16. Then, in step S16, a totaling result file K is generated by outputting a totaling result in units of records, according to group and totaling expressions, and the generated file K is outputted to a specified output destination. Then, a series of processes terminate. Otherwise, the determination is no, and the process returns to step S14. Then, in step S14, another totaling is similarly done by changing a node to which attention is paid.

Although in this preferred embodiment, a temporary file T is generated for a master file M and a journal file J, another temporary file T or a totaling result file K can also be specified. Alternatively, a totaling result file K can be generated using a plurality of temporary files T. Furthermore, alternatively, another totaling result file can also be specified as a target.

Although in this preferred embodiment, a temporary file T and a totaling result file K are separately generated in order to widely respond to a user's desire, a totaling result file K can also be directly generated using a master file M and a journal file J. In such a case, it is preferable for a user to be able to select the existence/non-existence of the output of a temporary file T.

Although in a master file M and a journal file J, data is described in the XML format, data can also be described in another format. It can also be a CSV file. The present invention can be applied to a variety of types of files by preparing information indicating data with what field is stored in what format in what form.

What is claimed is:

1. A storage medium which can be accessed by a data totaling device capable of extracting necessary data from one or more files and storing the data in another file and on which is recorded a program for realizing functions on the data totaling device, said functions comprising:
an information acquisition function for obtaining field information indicating a field of the necessary data; and
a data union function for extracting necessary data from one or more files, according to the field information obtained by the information acquisition function.

2. The storage medium according to claim 1, wherein
when extracting necessary data from a plurality of files, said data union function generates a status transition table using necessary data stored in at least one file, and extracts necessary data stored in the remaining file using the status transition table.

3. The storage medium according to claim 1, wherein
said information acquisition function can obtain operational information indicating an operation to be applied to the necessary data in addition to the field information, and
when said information acquisition function have obtained the operational information, said data union function stores the necessary data in a temporary file according to the field information, applies an operation indicated by the operational information to the necessary data stored in the temporary file and stores the data obtained by the operation in the other file together with at least one piece of the necessary data.

4. The storage medium according to claim 3, wherein
the operational information include another piece of field information indicating a field of data to be outputted to the other file, and
said data union function extracts data to be stored in the other filed from the temporary file, according to the other field information.

5. A storage medium which can be accessed by a data totaling device capable of storing data obtained by operating data stored in each of a plurality of files in another file and on which is recorded a program for realizing functions on the data totaling device, said functions comprising:
an information acquisition function for obtaining operational information indicating an operation to be applied to the data and a target data of the operation;
an operation function for extracting the target data of an operation from the plurality of files and executing the operation, according to the operational information obtained by the information acquisition function; and
a data output function for outputting data obtained by the operation of the operation function in the other file.

6. The storage medium according to claim 5, wherein
said operation function generates a status transition table using necessary data stored in one of the plurality of files and extracts necessary data stored in the remaining file using the status transition table.

7. A data totaling method for extracting necessary data from one or more files and storing the data in another file, comprising:
preparing a program for extracting necessary data from the one or more files, based on field information indicating a field of the necessary data and storing the data in another file; and
extracting the necessary data from the one or more files and storing the data in the other file by providing the program with the field information and executing the program.

8. The data totaling method according to claim 7, wherein
the program is made to correspond to another piece of operational information indicating an operation to be applied to the necessary data in addition to the field information, and
by providing the program with the field information and the operational information, extracting the necessary data from the one or more files, also applying the operation indicated by the operational information to the necessary data and storing the data obtained by the operation in the other file together with at least one piece of the necessary data.

9. The data totaling method according to claim 8, wherein
a first program made to correspond to the field information and a second program made to correspond to the operational information are prepared, and
an operation indicated by the operational information by the second program is applied to data that is stored in a file generated by the first program.

10. The data totaling method according to claim 9, wherein
the second program corresponds to operational information including another field information indicating a field of data to be outputted to the other file as the operational information.
